(19) United States
(12) Patent Application Publication
(10) Pub. No.: US 2026/0094752 A1
(43) Pub. Date: Apr. 2, 2026

(54) ANNULAR MAGNETIC ALIGNMENT COMPONENTS WITH SOFT MAGNETIC INSERTS

(71) Applicant: Apple Inc., Cupertino, CA (US)

(72) Inventors: Dariusz Bushko, Hopkinton, MA (US); Mark A. Hayner, Santa Clara, CA (US); Kevin R. Richardson, San Jose, CA (US); Karl Ruben F. Larsson, Scotts Valley, CA (US); Benjamin Morse, San Jose, CA (US); Robin Liu, Cupertino, CA (US); Jianqing Hu, Suzhou (CN); Kevin Woo Seok Yeom, Santa Clara, CA (US)

(73) Assignee: Apple Inc., Cupertino, CA (US)

(21) Appl. No.: 19/065,961

(22) Filed: Feb. 27, 2025

Related U.S. Application Data
(60) Provisional application No. 63/700,149, filed on Sep. 27, 2024.
(60) Provisional application No. 63/717,799, filed on Nov. 7, 2024.

(51) Int. Cl. H01F 7/02; H02J 50/00; H02J 50/10

(52) U.S. Cl. CPC H01F 7/0247; H02J 50/005; H02J 50/10

(57) ABSTRACT

An annular magnetic alignment component for a wireless charging system can include one or more arcuate inserts made of a soft magnetic material and disposed between arcuate magnets of the annular magnetic alignment component. When an annular magnetic alignment component is placed in an electronic device, the soft-magnetic arcuate inserts can provide magnetic shielding for electronic components located near the annular magnetic alignment component, which can reduce electronic and/or acoustic noise in the electronic device.

### CROSS-REFERENCE TO RELATED APPLICATION

This application claims the benefit of U.S. Provisional Application No. 63/700,149, filed Sep. 27, 2024, and of U.S. Provisional Application No. 63/717,799, filed Nov. 7, 2024, the disclosures of which are incorporated by reference herein.

### BACKGROUND

This disclosure relates generally to magnetic alignment systems for wireless charging and more specifically to annular magnetic alignment components that include one or more soft magnetic inserts.

Portable electronic devices (e.g., mobile phones, media players, electronic watches, and the like) operate when there is charge stored in their batteries. Some portable electronic devices include a rechargeable battery that can be recharged by coupling the portable electronic device to a power source through a physical connection, such as through a charging cord. Using a charging cord to charge a battery in a portable electronic device, however, requires the portable electronic device to be physically tethered to a power outlet. Additionally, using a charging cord requires the mobile device to have a connector, typically a receptacle connector, configured to mate with a connector, typically a plug connector, of the charging cord. The receptacle connector includes a cavity in the portable electronic device that provides an avenue via which dust and moisture can intrude and damage the device. Further, a user of the portable electronic device has to physically connect the charging cable to the receptacle connector in order to charge the battery.

To avoid such shortcomings, wireless charging technologies (also referred to as inductive charging technologies) have been developed that exploit electromagnetic induction to charge portable electronic devices without the need for a charging cord. For example, some portable electronic devices can be recharged by merely resting the device on a charging surface of a wireless charger device. A transmitter coil disposed below the charging surface is driven with an alternating current that produces a time-varying magnetic flux that induces a current in a corresponding receiver coil in the portable electronic device. The induced current can be used by the portable electronic device to charge its internal battery.

For devices with planar charging coils, it is desirable to align the coils coaxially during charging, to maximize efficiency of wireless power transfer. To facilitate alignment of the coils, some wireless charging systems incorporate magnetic alignment of the coils. For instance, complementary magnets can be placed in an area adjacent to the transmitter and receiver coils. When the devices are brought into proximity with each other, magnetic attraction between the magnets can help to align the coils and/or hold the devices in the desired alignment.

### SUMMARY

Magnetic alignment components can affect other electronic components of a portable device. For instance, the DC magnetic field of a magnetic alignment component can exert a force on an inductor or other component(s) on a logic board in the portable device, resulting in electronic noise, unwanted vibration (which can create acoustic noise), or the like.

According to some embodiments, an annular magnetic alignment component can include one or more arcuate inserts made of a soft magnetic material and disposed between arcuate magnets of the annular magnetic alignment component. Such arcuate inserts can provide magnetic shielding for electronic components located near the annular magnetic alignment component, which can reduce electronic and/or acoustic noise.

Some embodiments relate to magnetic alignment components that can include a number of arcuate magnets arranged end-to end to define an annular shape. The arcuate magnets can be made of a permanent magnetic material and can have a magnetic orientation with a component in a radial direction. The arcuate magnets can also have a uniform height in an axial direction transverse to the annular shape. The arcuate magnets can be arranged such that a first gap in the annular shape is present between a first pair of the arcuate magnets. A first insert can be disposed in the first gap. The first insert can be made of a soft magnetic material (rather than a permanent magnet or hard magnetic material). The first insert can have a height less than the uniform height of the arcuate magnets and an arcuate shape that fills the first gap.

Some embodiments relate to an electronic device that can include a housing having a charging surface, a logic board disposed in the housing and having electronic circuit components disposed thereon, a magnetic alignment component disposed between the logic board and the charging surface such that at least a portion of the magnetic alignment component overlies a portion of the logic board, and an inductive charging coil disposed inboard of and coaxial with the magnetic alignment component. The magnetic alignment component can include a number of arcuate magnets arranged end-to end to define an annular shape. The arcuate magnets can be made of a permanent magnetic material and can have a magnetic orientation with a component in a radial direction. The arcuate magnets can also have a uniform height in an axial direction transverse to the annular shape. The arcuate magnets can be arranged such that a first gap in the annular shape is present between a first pair of the arcuate magnets. This gap can be located in the portion oft the annular magnetic alignment component that overlies the portion of the logic board A first insert can be disposed in the first gap. The first insert can be made of a soft magnetic material (rather than a permanent magnet or hard magnetic material), such as steel. The first insert can have a height less than the uniform height of the arcuate magnets and an arcuate shape that fills the first gap. An electrical connection to the inductive charging coil can pass over the first insert.

In these and other embodiments, the arcuate magnets can be arranged such that a second gap in the annular shape is present between a second pair of the arcuate magnets. The second gap can be in a portion of the magnetic alignment component that overlies an inductor component on the logic board. The magnetic alignment component can further include a second insert disposed in the second gap, the second insert being made of a soft magnetic material, the second insert having a height equal to the uniform height of the arcuate magnets and an arcuate shape that closes the second gap. In some embodiments, an arc length of the second gap and the second insert can be selected to minimize a net force acting on the inductor component on the logic board.

In these and other embodiments, for efficiency of manufacturing, an inner radius of curvature of each of the arcuate magnets can be made equal to an outer radius of curvature of each of the arcuate magnets. The inner radius of curvature of the first insert can also be equal to the outer radius of curvature of the first insert.

The following detailed description, together with the accompanying drawings, will provide a better understanding of the nature and advantages of the claimed invention.

### BRIEF DESCRIPTION OF THE DRAWINGS

FIGS. 1A and 1B show perspective views of an annular magnetic alignment component according to some embodiments.

FIG. 2 shows a simplified back view of a portable electronic device according to some embodiments.

FIG. 3A shows a perspective view of a magnetic alignment system according to some embodiments, and FIG. 3B shows a cross-section through magnetic alignment system across the cut plane indicated in FIG. 3A.

FIGS. 4A and 4B show two-dimensional maps of magnetic field strength measured at different (x, y) locations on a logic board of devices incorporating annular magnetic alignment components.

FIG. 5 shows a graph of an effect of an arcuate insert on attachment strength between magnetic alignment components according to some embodiments.

FIGS. 6A and 6B show perspective views of an annular magnetic alignment component according to some embodiments.

FIG. 7 shows a simplified back view of a portable electronic device according to some embodiments.

FIGS. 8A-8C illustrate tuning of sizes of arcuate inserts according to some embodiments.

FIG. 9 shows a plan view of an arcuate magnet that can be used in an annular magnetic alignment component

FIG. 10 shows a simplified illustration of a pattern for laser-cutting arcuate magnets from a sheet of magnetic material.

FIG. 11 shows a plan view of an optimized arcuate magnet according to some embodiments.

FIG. 12 shows a simplified illustration of a pattern for laser-cutting arcuate magnets from a sheet of magnetic material according to some embodiments.

### DETAILED DESCRIPTION

The following description of exemplary embodiments of the invention is presented for the purpose of illustration and description. It is not intended to be exhaustive or to limit the claimed invention to the precise form described, and persons skilled in the art will appreciate that many modifications and variations are possible. The embodiments have been chosen and described in order to best explain the principles of the invention and its practical applications to thereby enable others skilled in the art to best make and use the invention in various embodiments and with various modifications as are suited to the particular use contemplated.

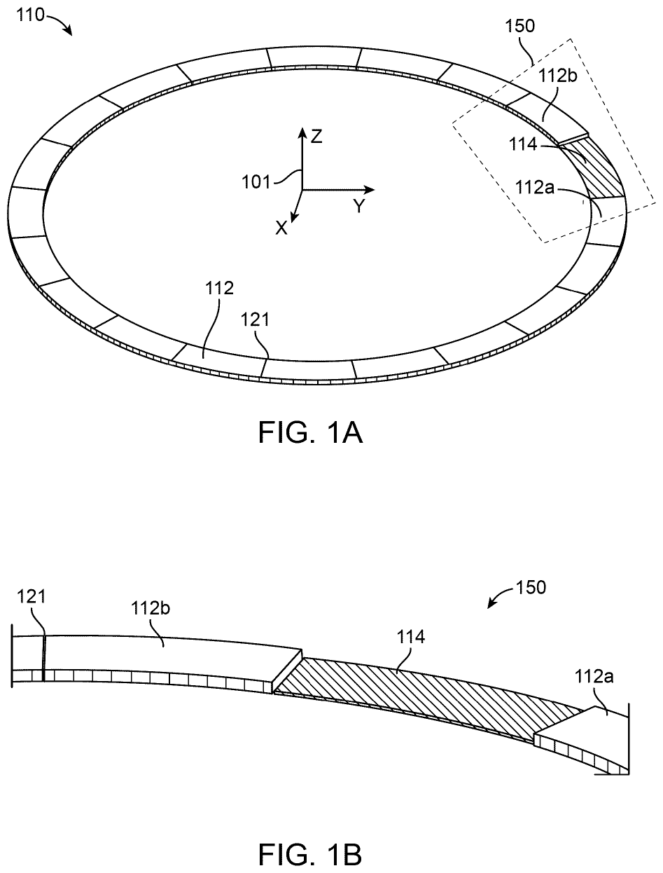

FIGS. 1A and 1B show perspective views of an annular magnetic alignment component 110 according to some embodiments. FIG. 1A shows a perspective view of the entire component; FIG. 1B shows an enlarged view of region 150 indicated in FIG. 1A. A coordinate axis 101 is defined for convenience, with the origin at the center of annular magnetic alignment component 110 and the z axis extending transverse to the plane of annular magnetic alignment component 110.

As shown in FIG. 1A, annular magnetic alignment component 110 can include a number of arcuate magnets 112 arranged to form an annular shape, or ring. Arcuate magnets 112 can be made of a permanent (or hard) magnetic material such as an NdFeB material, other rare earth magnetic materials, or other materials that can be magnetized to create a persistent magnetic field. Each arcuate magnet 112 can have a dipole magnetization with magnetic polarity having a component in the radial direction in the transverse plane. For example, the magnetic polarity can be in a radially inward direction in the xy plane. In some embodiments, each arcuate magnet 112 can be made of a magnetic material that has been ground into a sheet and cut into an arcuate structure (e.g., using laser cutting as described below), and a dipole magnetization having a radial component in the transverse plane can be created in each arcuate magnet 112, e.g., using a magnetizer. Arcuate magnets 112 can be shaped such that when arcuate magnets 112 are positioned adjacent to one another end-to-end, arcuate magnets 112 form an annular shape as shown. In some embodiments, arcuate magnets 112 can be in contact with each other at end-to-end interfaces 121. Alternatively, small gaps or spaces may separate adjacent arcuate magnets 112, providing a greater degree of tolerance during manufacturing. For convenience of manufacturing, all arcuate magnets 112 can have the same arc length. For instance, in the example shown in FIGS. 1A and 1B, each arcuate magnet 112 subtends an arc of 18 degrees, and annular magnetic alignment component 110 includes nineteen arcuate magnets 112.

Annular magnetic alignment component 110 can include a gap between two arcuate magnets 112a, 112b. According to some embodiments, an arcuate insert 114 can be disposed in this gap. Unlike arcuate magnets 112, arcuate insert 114 is not a permanent magnet. Instead, arcuate insert 114 is made of a soft magnetic material such as steel (e.g., 430 stainless steel or 1010 steel) or another soft magnetic material that can temporarily develop a net magnetization in the presence of a magnetic field. (It should be understood that “soft” refers to the magnetic properties of the material and that arcuate insert 114 can be a rigid body.) Arcuate insert 114 can have the same arc length and radial width as arcuate magnets 112.

As best seen in FIG. 1B, the height (thickness in the z-direction) of arcuate insert 114 can be less than the height of arcuate magnets 112. For example, the height of arcuate insert 114 can be between about 20% and 50% of the height of arcuate magnets 112 or between about 10% and 80% of the height of arcuate magnets 112. The reduced height of arcuate insert 114 can create space for physical connections (e.g., electrical connection paths for a wireless charging coil) to extend over arcuate insert 114 between the inboard and outboard regions of annular magnetic alignment component 110 without requiring the connections to extend in the z-direction beyond the top surface of annular magnetic alignment component 110 (the top surface in this context is defined by arcuate magnets 112). An example is shown below.

The dimensions of annular magnetic alignment component 110 can be varied as desired. In some embodiments, annular magnetic alignment component 110 can have an outer diameter of about 50 mm and a radial width of about 3 mm. Arcuate magnets 112 can have a thickness of about 0.37 mm, and arcuate insert 114 can have a thickness of about 0.1 mm. (All numerical values herein are examples and may be varied as desired.) The number of arcuate magnets can be modified, and the arc lengths of the arcuate magnets and the arcuate insert can be but need not be the same. Further, different arcuate magnets can have different arc lengths if desired.

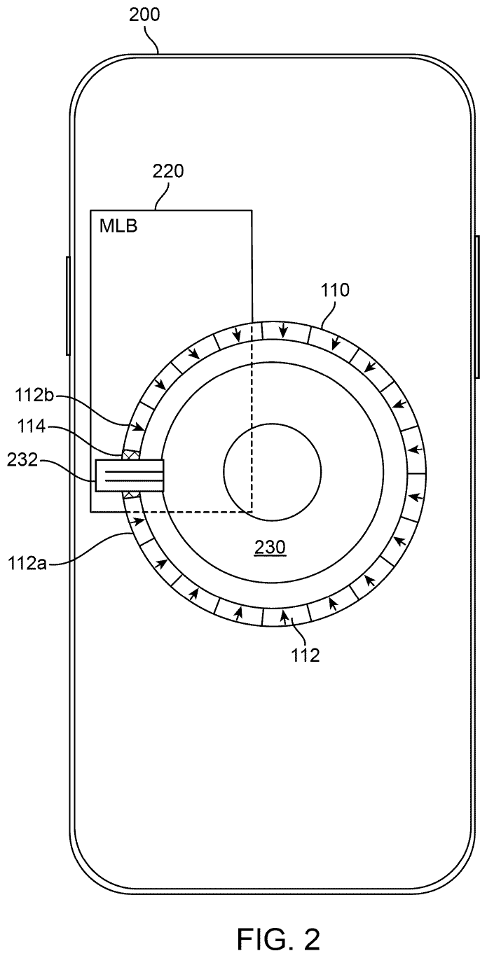

FIG. 2 shows a simplified back view of a portable electronic device 200 according to some embodiments. In this example, portable electronic device 200 is a smart phone, but other devices having different form factors can be substituted. Portable electronic device 200 can include annular magnetic alignment component 110 described above, as well as other components such as a main logic board (MLB) 220, and a wireless receiver coil assembly 230.

Main logic board 220 can be a printed circuit board having various electronic components disposed thereon to control various operations of portable electronic device 200. Such components can include microprocessors, microcontrollers, memory circuits, power circuitry, and any other electronic components.

Wireless receiver coil assembly 230 can include a wireless receiver coil for inductive power transfer from another device as well as AC magnetic and/or electric shield(s) disposed around some or all surfaces of the wireless receiver coil. The particular implementation of wireless receiver coil assembly 230 can be modified as desired. As shown in FIG. 1, a coil connector 232 can provide electrical connection paths to the ends of the wireless receiver coil in wireless receiver coil assembly 230. For example, coil connector 232 can be implemented as a flexible printed circuit board with conductive traces printed thereon that connect to the inner and outer ends of the wireless receiver coil. Alternatively, coil connector 232 can be implemented using a pair of wires that extend from or connect to the inner and outer ends of the wireless charging coil. Coil connector 232 can also be connected to main logic board 220, and main logic board 220 can include conductive paths and circuitry to use current received via coil connector 232 to charge an internal battery of portable electronic device 100 (not shown in FIG. 1). The total height of arcuate insert 114 and coil connector 232 can be equal to or less than the height of arcuate magnets 112, helping to keep portable electronic device 200 thin.

Annular magnetic alignment component 110 can be disposed around wireless receiver coil assembly 230. Arcuate magnets 112 can be dipole magnets with magnetic polarity oriented radially inward, as suggested by the arrows. Coil connector 232 can pass over arcuate insert 114 of annular magnetic alignment component 110 to enable electrical connections between wireless receiver coil assembly 230 and circuitry disposed outboard of annular magnetic alignment component 110 (e.g., on main logic board 220 or located elsewhere within portable electronic device 200).

It should be understood that portable electronic device 200 may include other components not shown in FIG. 2; examples include batteries, camera systems, microphones, displays, input devices (e.g., touchscreen and/or buttons), wireless communication devices (antennas and supporting circuitry), and so on. It should also be understood that portable electronic device 200 may have an opaque rear housing (not shown in FIG. 2) so that components such as wireless receiver coil assembly 230, main logic board 220, and annular magnetic alignment component 110 are not visible to a user. Portable electronic device 200 is illustrative of a category of devices that can benefit from magnetic alignment components of the kind described herein, and embodiments of the invention are not limited to any particular electronic device.

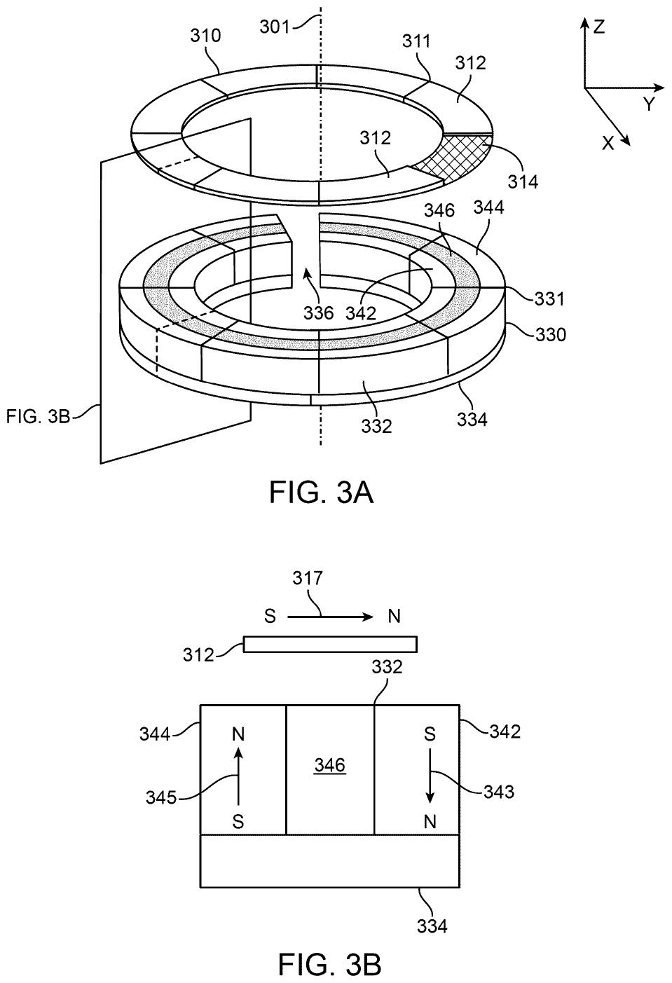

In some embodiments, an annular magnetic alignment component such as annular magnetic alignment component 110 can attract and attach to a complementary annular magnetic alignment component in a wireless power transmitter device. FIG. 3A shows a perspective view of a magnetic alignment system 300 according to some embodiments, and FIG. 3B shows a cross-section through magnetic alignment system 300 across the cut plane indicated in FIG. 3A.

As shown in FIG. 3A, magnetic alignment system 300 can include a primary alignment component 330 and a secondary alignment component 310. Primary alignment component 330 and secondary alignment component 310 have annular shapes, and secondary alignment component 310 can correspond to annular magnetic alignment component 110 of FIG. 1. The particular dimensions can be chosen as desired. In some embodiments, primary alignment component 330 and secondary alignment component 310 can each have an outer diameter of about 54 mm and a radial width of about 4 mm. The outer diameters and radial widths of primary alignment component 330 and secondary alignment component 310 need not be exactly equal. For instance, the radial width of secondary alignment component 310 can be slightly less than the radial width of primary alignment component 330 and/or the outer diameter of secondary alignment component 310 can also be slightly less than the radial width of primary alignment component 330 so that, when in alignment, the inner and outer sides of primary alignment component 330 extend beyond the corresponding inner and outer sides of secondary alignment component 310. Height (or thickness in the z direction) of primary alignment component 330 and secondary alignment component 310 can also be chosen as desired. In some embodiments, primary alignment component 310 has a height of about 1.5 mm while secondary alignment component 310 has a height of about 0.37 mm. (All numerical values herein are examples and may be varied as desired.)

Primary alignment component 330 can include a number of primary magnets 332, and secondary alignment component 310 can include a number of secondary magnets 312. In the example shown, the number of primary magnets 332 is equal to the number of secondary magnets 312, but this is not required. Primary magnets 332 and secondary magnets 312 can have arcuate shapes such that when primary magnets 332 (or secondary magnets 312) are positioned adjacent to one another end-to-end, primary magnets 332 (or secondary magnets 312) form an annular shape as shown. In some embodiments, primary magnets 332 can be in contact with each other at interfaces 331, and secondary magnets 312 can be in contact with each other at interfaces 311. Alternatively, small gaps or spaces may separate adjacent primary magnets 332 or secondary magnets 312, providing a greater degree of tolerance during manufacturing.

Secondary alignment component 310 can also include an arcuate insert 314 made of soft magnetic material. Arcuate insert 314 can be similar or identical to arcuate insert 114 described above. Primary alignment component 330 can include a gap 336 between two of primary magnets 332 (e.g., to accommodate electrical connections to a wireless power transmitter coil and/or other electronic components that may be located inboard of primary alignment component 330). Gap 336 need not be aligned in any particular rotational orientation relative to arcuate insert 314.

In some embodiments, primary alignment component 330 can also include an annular shield 334 (also referred to as a DC magnetic shield or DC shield) disposed on a distal surface of primary magnets 332. In some embodiments, DC shield 334 can be formed as a single annular piece of material and adhered to primary magnets 332 to secure primary magnets 332 into position. DC shield 334 can be formed of a material that has high magnetic permeability and/or high magnetic saturation value, such as stainless steel or low-carbon steel, and can redirect magnetic fields to prevent them from propagating beyond the distal side of primary alignment component 330, thereby protecting sensitive electronic components located beyond the distal side of primary alignment component 330 from magnetic interference.

Primary magnets 332 and secondary magnets 312 can be made of a magnetic material such as an NdFeB material, other rare earth magnetic materials, or other materials that can be magnetized to create a persistent magnetic field. Each secondary magnet 312 can have a single magnetic region with a magnetic polarity having a component in the radial direction in the transverse plane (as shown by magnetic polarity indicator 317 in FIG. 3B). The magnetic orientation can be in a radial direction with respect to axis 301 or another direction having a radial component in the transverse plane. Each primary magnet 332 can include two magnetic regions having opposite magnetic orientations. For example, each primary magnet 332 can include an inner arcuate magnetic region 342 having a magnetic orientation in a first axial direction (as shown by polarity indicator 343 in FIG. 3B), an outer arcuate magnetic region 344 having a magnetic orientation in a second axial direction opposite the first direction (as shown by polarity indicator 345 in FIG. 3B), and a central arcuate region 346 that is non-magnetized. Central arcuate region 346 can magnetically separate inner arcuate magnetic region 342 from outer arcuate magnetic region 344 by inhibiting magnetic fields from directly crossing through central arcuate region 346. Magnets having regions of opposite magnetic orientation separated by a non-magnetized region are sometimes referred to herein as having a “quad-pole” configuration.

As shown in FIG. 3B, the magnetic polarity of secondary magnets 312 (shown by indicator 317) can be oriented such that when primary alignment component 330 and secondary alignment component 310 are aligned, the south pole of secondary magnet 312 is oriented toward the north pole of outer arcuate magnetic region 344 (shown by indicator 345) while the north pole of secondary magnet 312 is oriented toward the south pole of inner arcuate magnetic region 342 (shown by indicator 343). Accordingly, the respective magnetic orientations of inner arcuate magnetic region 342, secondary magnet 312 and outer arcuate magnetic region 344 can generate magnetic fields that exert an attractive force between primary magnet 332 and secondary magnet 312, thereby facilitating alignment between respective electronic devices in which primary alignment component 330 and secondary alignment component 310 are disposed. DC shield 334 can redirect magnetic fields away from regions below primary magnet 332. Further, the “closed-loop” magnetic field formed around central non-magnetized region 346 can have tight and compact field lines so that stray fields are reduced in areas outside of primary and secondary magnets 332 and 312.

It will be appreciated that magnetic alignment system 300 is illustrative and that variations and modifications are possible. For instance, while primary alignment component 330 and secondary alignment component 310 are each shown as being constructed of eight arcuate magnets, other embodiments may use a different number of magnets, such as 16 magnets, 18 magnets, 20 magnets, 32 magnets, 36 magnets, or any other number of magnets, and the number of primary magnets need not be equal to the number of secondary magnets. In other embodiments, secondary alignment component 310 can be formed of a single, monolithic magnet with an arcuate insert 314. Similarly, primary alignment component 330 can be formed of a single, monolithic piece of magnetic material with an appropriate magnetization pattern as described above, or primary alignment component 330 can be formed of a monolithic inner magnet and a monolithic outer magnet, with an annular air gap or region of nonmagnetic material disposed between the inner magnet and outer magnet. In some embodiments, a construction using multiple arcuate magnets may improve manufacturing because smaller arcuate magnets are less brittle than a single, monolithic annular (or nearly annular) magnet and are less prone to yield loss due to physical stresses imposed on the magnetic material during manufacturing. It should also be understood that the magnetic orientations of the various magnetic alignment components or individual magnets do not need to align exactly with the radial and axial directions. The magnetic orientation can have any angle that provides a closed-loop path for a magnetic field through the primary and secondary alignment components.

Referring again to FIG. 2, in some embodiments, arcuate insert 114 can provide DC magnetic shielding for various components of portable electronic device 200, such as main logic board 220, particularly when a primary alignment component (such as primary alignment component 330) is attached. As compared to alternative implementations where arcuate insert 114 is absent and an air gap (or only non-magnetic material) is present between arcuate magnets 112a, 112b of annular magnetic alignment component 110, a magnetic alignment component that includes arcuate insert 114 can reduce magnetic fields present at portions of main logic board 220.

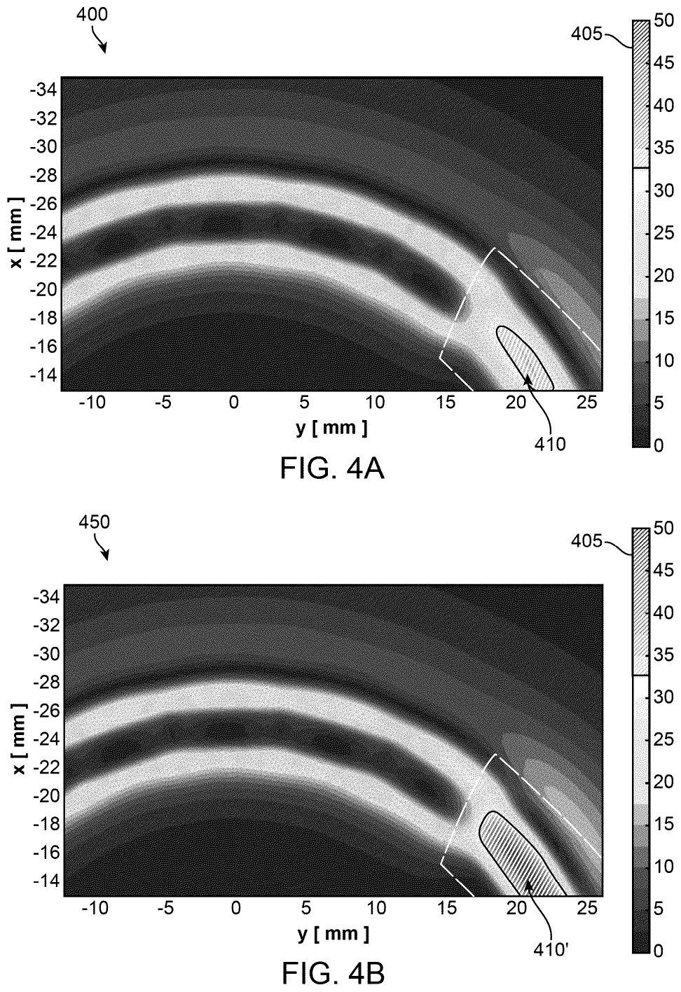

By way of example, FIGS. 4A and 4B show two-dimensional maps 400 and 450 of magnetic field strength measured at different (x, y) locations on a main logic board of a portable electronic device such as device 200 of FIG. 2 when a primary alignment component 330 is attached to annular magnetic alignment component 110. Magnetic field strength is represented using shading scale 405. FIG. 4A shows a magnetic field map for a portable electronic device where arcuate insert 114 is present and overlies region 410. As can be seen, the magnetic field in region 410 is somewhat higher than other regions along the arc of annular magnetic alignment component 110. For comparison, FIG. 4B shows a corresponding plot for a portable electronic device where arcuate insert 114 is absent and an air gap in annular magnetic alignment component 110 overlies region 410′. As can be seen by comparing FIGS. 4A and 4B, arcuate insert 114 can provide significant shielding, as compared to having an air gap.

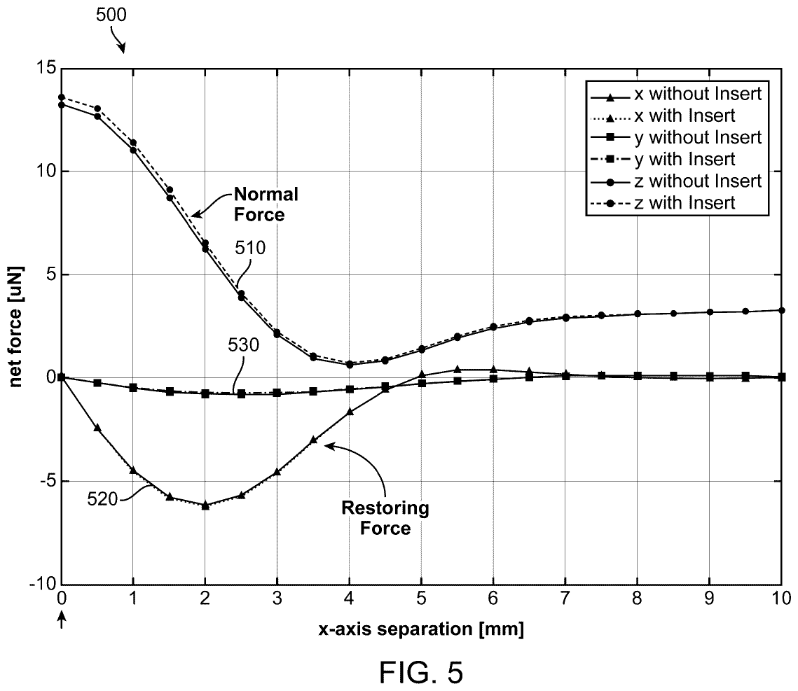

FIG. 5 shows a graph 500 of the effect of arcuate insert 314 on attachment strength between secondary alignment component 310 and primary alignment component 330 of FIG. 3A according to some embodiments. Curve 510 plots the normal force (attraction in the z direction) between secondary alignment component 310 and primary alignment component 330 as a function of lateral displacement of secondary alignment component 310 in the x direction. (Zero on the x-axis corresponds to coaxial alignment.) Curve 520 plots the restoring force (attraction toward coaxial alignment) in the x direction, and curve 530 plots the restoring force in the y direction. (Displacement in the x direction has little effect on the restoring force in the y direction.) For each force, a solid curve shows the force when arcuate insert 314 is absent, and a dashed curve shows the force when arcuate insert 314 is present. As can be seen, arcuate insert 314 can increase the normal force somewhat and has negligible effect on the restoring force. Thus, arcuate insert 314 can provide improved magnetic shielding for the logic board (e.g., as shown in FIG. 4A) without adversely affecting the alignment and attachment performance of an annular magnetic alignment component.

In examples described above, an arcuate insert can provide a shielded path for electrical connections (e.g., coil connector 232) between the inboard and outboard regions of an annular magnetic alignment component. According to some embodiments, additional arcuate inserts made of soft magnetic material can also be used to provide shielding for specific components n a logic board of an electronic device. Examples will now be described.

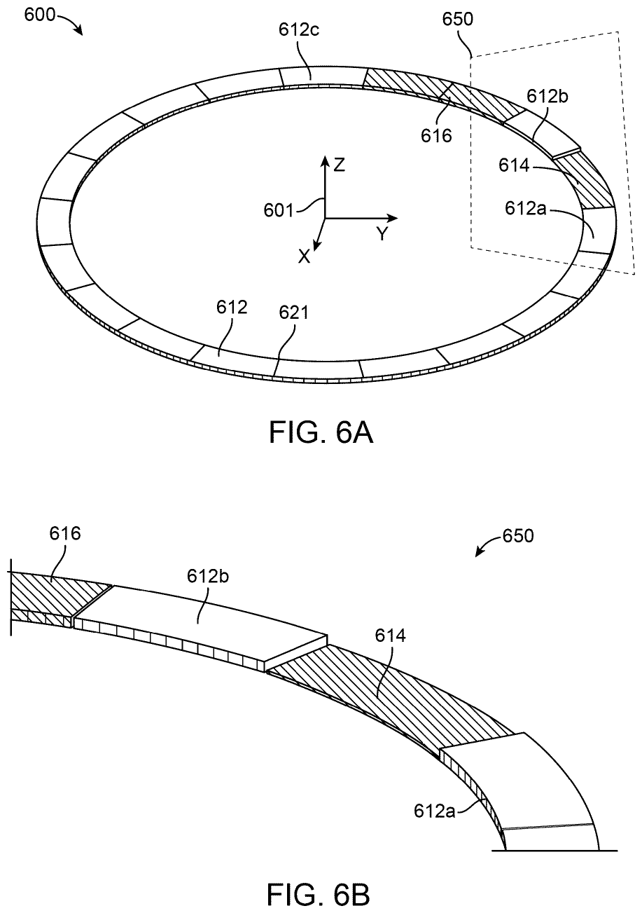

FIGS. 6A and 6B show perspective views of an annular magnetic alignment component 610 according to some embodiments. FIG. 6A shows a perspective view of the entire component; FIG. 6B shows an enlarged view of region 650 indicated in FIG. 6A. A coordinate axis 601 is defined for convenience, with the origin at the center of annular magnetic alignment component 610 and the z axis extending transverse to the plane of annular magnetic alignment component 610.

As shown in FIG. 6A, annular magnetic alignment component 610 can include a number of arcuate magnets 612 arranged to form an annular shape, or ring. Like arcuate magnets 112 described above, arcuate magnets 612 can be made of a permanent (or hard) magnetic material such as an NdFeB material, other rare earth magnetic materials, or other materials that can be magnetized to create a persistent magnetic field. Each arcuate magnet 612 can have a dipole magnetization with magnetic polarity having a component in the radial direction in the transverse plane. For example, the magnetic polarity can be in a radially inward direction in the xy plane. In some embodiments, each arcuate magnet 612 can be made of a magnetic material that has been ground into a sheet and cut into an arcuate structure (e.g., using laser cutting as described below), and a dipole magnetization having a radial component in the transverse plane can be created, e.g., using a magnetizer. Arcuate magnets 612 can be shaped such that when arcuate magnets 612 are positioned adjacent to one another end-to-end, arcuate magnets 612 form an annular shape as shown. In some embodiments, arcuate magnets 612 can be in contact with each other at end-to-end interfaces 621. Alternatively, small gaps or spaces may separate adjacent arcuate magnets 612, providing a greater degree of tolerance during manufacturing. For convenience of manufacturing, all arcuate magnets 612 can have the same arc length. For instance, in the example shown in FIGS. 6A and 6B, each arcuate magnet 612 subtends an arc of 18 degrees, and annular magnetic alignment component 610 includes seventeen arcuate magnets 612.

Similarly to annular magnetic alignment component 110, annular magnetic alignment component 610 can include a first gap between two arcuate magnets 612a, 612b. According to some embodiments, a first arcuate insert 614 can be disposed in this gap. In addition, annular magnetic alignment component 610 can include a second gap between two arcuate magnets 612b, 612c, and a second arcuate insert 616 can be disposed in the second gap. Unlike arcuate magnets 612, first arcuate insert 614 and second arcuate insert 616 are not permanent magnets. Instead, like arcuate insert 114 described above, first arcuate insert 614 and second arcuate insert 616 can be made of a soft magnetic material such as steel (e.g., 430 stainless steel or 1010 steel) or another soft magnetic material that can temporarily develop a net magnetization in the presence of a magnetic field. First arcuate insert 614 can have the same arc length and radial width as arcuate magnets 612. Second arcuate insert 616 in this example has the same radial width as arcuate magnets 612 and an arc length that is twice the arc length of an arcuate magnet 612.

As best seen in FIG. 6B, the height (thickness in the z-direction) of first arcuate insert 614 can be less than the height of arcuate magnets 612. For example, the height of arcuate insert 614 can be between about 20% and 50% of the height of arcuate magnets 612 or between about 10% and 80% of the height of arcuate magnets 612. The reduced height of arcuate insert 614 can create space for physical connections (e.g., electrical connection paths for a wireless charging coil) to extend over first arcuate insert 614, similarly to arcuate insert 114 described above. Second arcuate insert 616 can have a height equal to the height of arcuate magnets 612. In some embodiments, second arcuate insert 616 can provide shielding for one or more electronic components on a logic board of a processor. An example is described below.

The dimensions of annular magnetic alignment component 610 can be varied as desired. In some embodiments, annular magnetic alignment component 610 can have an outer diameter of about 50 mm and a radial width of about 3 mm. Arcuate magnets 612 and second arcuate insert 616 can have a thickness of about 0.37 mm, and first arcuate insert 614 can have a thickness of about 0.1 mm. (All numerical values herein are examples and may be varied as desired.) The number of arcuate magnets can be modified, and the arc lengths of the arcuate magnets and the arcuate inserts can be but need not be the same. Further, different arcuate magnets and/or different arcuate inserts can have different arc lengths if desired.

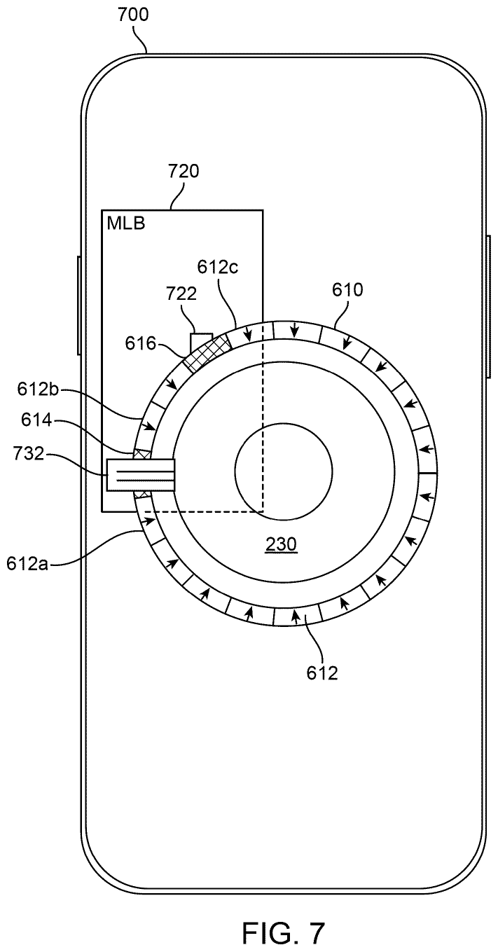

FIG. 7 shows a simplified back view of a portable electronic device 700 according to some embodiments. In this example, portable electronic device 700 is a smart phone, but other devices having different form factors can be substituted. Portable electronic device 700 can be generally similar to portable electronic device 200 described above. For instance, portable electronic device 700 can include a main logic board 720 and a wireless receiver coil assembly 730 having a coil connector 732; these components can be similar or identical to corresponding components of portable electronic device 200 described above. Portable electronic device 700 can also include annular magnetic alignment component 610.

Annular magnetic alignment component 610 can be disposed around wireless receiver coil assembly 730. Arcuate magnets 612 can be dipole magnets with magnetic polarity oriented radially inward, as suggested by the arrows. Coil connector 732 can pass over first arcuate insert 614 of annular magnetic alignment component 610 to enable electrical connections between wireless receiver coil assembly 730 and circuitry disposed outboard of annular magnetic alignment component 610 (e.g., on main logic board 720 or located elsewhere within portable electronic device 700).

Components mounted on main logic board 720 can include an inductor 722 that is positioned under a portion of annular magnetic alignment component 610. In this configuration, annular magnetic alignment component 610 can exert mechanical force on inductor 622. For instance, as is known in the art, inductor 722 can be modeled as a magnetic dipole moment m_{z}, and a Lorentz force in the z direction (F_{z}) exerted on inductor 722 by annular magnetic alignment component 610 can be approximated by a product of the magnetic dipole moment m_{z} and the gradient of the z-component of the DC magnetic field. This force can create noise (including electronic noise and/or acoustic noise or vibration) in inductor 722. For instance, when a primary alignment component (e.g., primary alignment component 330) is attached, the DC magnetic field around the edges of annular magnetic alignment component 610 can have a gradient in the z direction that can produce a Lorentz force on inductor 722.

According to some embodiments, annular magnetic alignment component 610 can be positioned relative to main logic board 720 such that inductor 722 is positioned under a portion of second arcuate insert 616, as shown in FIG. 7. Replacing an arcuate magnet 612 with second arcuate insert 616 can reduce the DC magnetic field gradient experienced at the location of inductor 722 when a complementary annular magnetic alignment component, such as primary alignment component 330 described above, is attached. Thus, second arcuate insert 616 can help to reduce noise from inductor 722. (When no primary alignment component is attached, annular magnetic alignment component 610 produces a magnetic field whose z component has a negligible gradient at the location of inductor 722.)

While one inductor 722 is shown, it should be understood that main logic board 720 can include multiple inductors at various locations. Main logic board 720 can also include conductive traces (e.g., copper traces printed on a surface of main logic board 720 and/or between insulating layers). Lorentz forces can act on any or all of these components, and one or more arcuate inserts 616 can be used to reduce force on various components and/or traces of main logic board 720. In some embodiments, one or more non-magnetic gaps (e.g., air gaps or gaps filled with a non-magnetic material such as plastic, aluminum, or the like) can be used instead of an arcuate insert 616. Arcuate inserts and non-magnetic gaps can be used in any combination. Those skilled in the art will appreciate that the optimal number and arrangement of arcuate inserts and/or non-magnetic gaps depends on the particular design of the main logic board.

As with portable electronic device 200, it should be understood that portable electronic device 700 may include other components not shown in FIG. 7; examples include batteries, camera systems, microphones, displays, input devices (e.g., touchscreen and/or buttons), wireless communication devices (antennas and supporting circuitry), and so on. It should also be understood that portable electronic device 700 may have an opaque rear housing (not shown in FIG. 7) so that components such as wireless receiver coil assembly 730, main logic board 720, and annular magnetic alignment component 610 are not visible to a user. Portable electronic device 700 is illustrative of a category of devices that can benefit from magnetic alignment components of the kind described herein, and embodiments of the invention are not limited to any particular electronic device.

According to various embodiments, the size and positioning of arcuate soft magnetic inserts within an annular magnetic alignment component can be tuned to optimize noise reduction. For instance, the arc length of second arcuate insert 616 can be increased or decreased, depending on the particular electronic components for which shielding is desired. In some embodiments, the arc length of first arcuate insert 614 can be correspondingly decreased or increased.

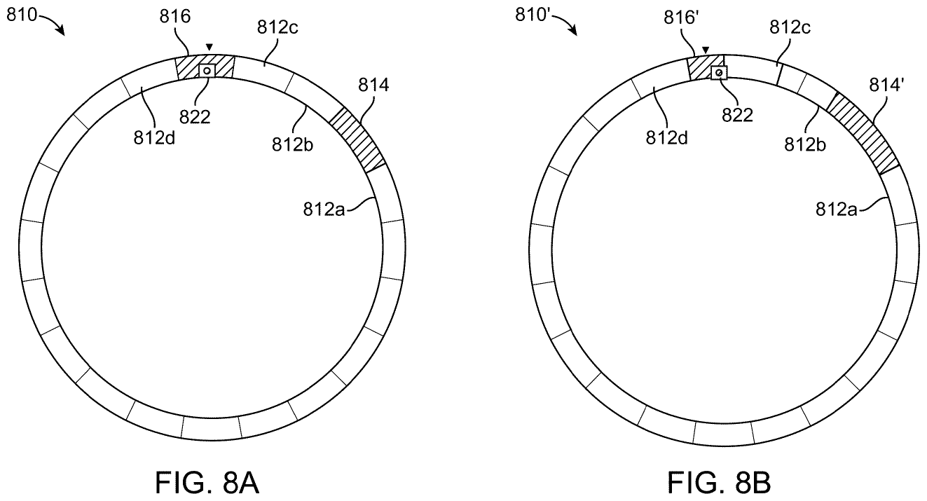

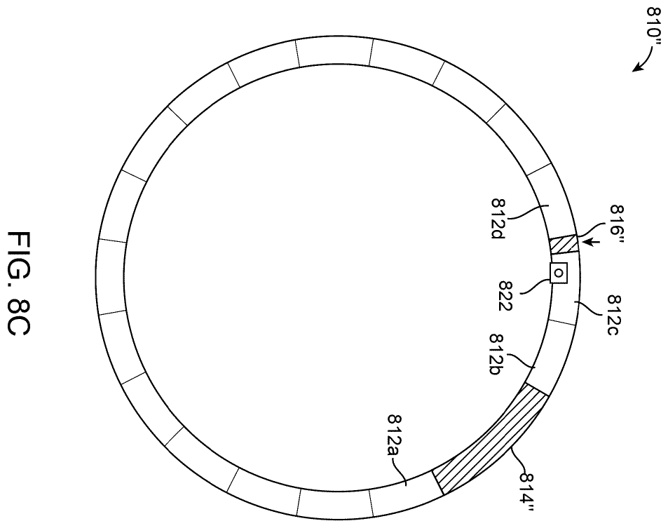

FIGS. 8A-8C illustrate tuning of the arc length arcuate inserts according to some embodiments. FIG. 8A shows a plan view of an annular magnetic alignment component 810 in a baseline configuration. In the baseline configuration, annular magnetic alignment component 810 includes eighteen arcuate magnets 812, each having an arc length that subtends an angle of 18 degrees. A first arcuate insert 814 is placed in a gap between two arcuate magnets 812a, 812b, and a second arcuate insert 816 is placed in a gap between two other arcuate magnets 812c, 812d. First arcuate insert 814 can be a reduced-height insert (similar to arcuate inserts 114 and 614 described above), while second arcuate insert 816 can have the same height as arcuate magnets 812. An inductor 822 on a logic board is located under second arcuate insert 816. In the baseline configuration of FIG. 8A, each of arcuate inserts 814, 816 has an arc length equal to the arc length of arcuate magnets 812, and second arcuate insert 816 has a volume equal to the volume of one of arcuate magnets 812.

FIG. 8B shows a plan view of an annular magnetic alignment component 810′, which can be identical to annular magnetic alignment component 810, except that second arcuate insert 816′ has a decreased arc length while first arcuate insert 814′ has a correspondingly increased arc length. For instance, second arcuate insert 816′ can have a volume equal to 60% of the volume of one of arcuate magnets 812. The shielding provided by second arcuate insert 816′ is thereby decreased relative to the baseline configuration.

FIG. 8C shows a plan view of an annular magnetic alignment component 810″, which can also be identical to annular magnetic alignment component 810, except that second arcuate insert 816″ has an arc length that is decreased even further than in FIG. 8B while first arcuate insert 814″ has a correspondingly increased arc length. For instance, second arcuate insert 816″ can have a volume equal to 20% of the volume of one of arcuate magnets 812. The shielding provided by second arcuate insert 816″ is thereby further decreased relative to the configuration of FIG. 8B. Although not shown, in some embodiments, the arc length of second arcuate insert 816 can be increased to be longer than the arc length of one of arcuate magnets 812; however, since increasing the arc length of second arcuate insert 816 corresponds to decreasing the arc length of first arcuate insert 814, the maximum arc length of second arcuate insert 816 may be subject to a constraint that the minimum arc length of first arcuate insert 814 be long enough to allow a coil connector (e.g., as described above) to pass through the reduced-height region provided by first arcuate insert 814.

It should be noted that the configurations of FIGS. 8A-8C can use the same arcuate magnets 812. Accordingly, an optimal configuration for purposes of noise reduction can be “dialed in” during product design without affecting design or manufacturing specifications of arcuate magnets 812. For instance, force modeling software (examples of which are known in the art) can be used to determine an arc length (or volume) for second arcuate insert 816 that provides optimum noise reduction for a given design of the logic board that holds inductor 822. Those skilled in the art will appreciate that inductor 822 may be subject to multiple forces from different sources, and it is not necessarily the case that increasing the arc length of second arcuate insert 816 would result in improved noise performance.

The foregoing examples are illustrative of annular magnetic alignment components having one or more arcuate inserts made of a soft magnetic material (such as steel) rather than permanent magnets. As described above, at least one of the arcuate inserts can have a reduced height to facilitate electrical connections between a component inboard of the annular magnetic alignment component (e.g., a wireless charging coil) and a component outboard of the annular magnetic alignment component (e.g., a main logic board or other circuitry that receives current from or supplies current to the wireless charging coil). One or more other arcuate inserts having the same height as the magnets of the annular magnetic alignment component can also be provided, e.g., for noise reduction in a particular electronic component. The number of arcuate inserts, the arc length of each arcuate insert, and the arc length of the arcuate magnets can be modified as desired. Further, while the annular magnetic alignment components described above are formed using arcuate magnets of uniform arc length, this is for convenience, and different arcuate magnets can have different arc lengths. Any number of arcuate magnets (one or more) can be used In one extreme case, a single arcuate magnet with a “C” shape can be used; the “C” shape has a gap that can be filled with an arcuate insert of the kind described herein.

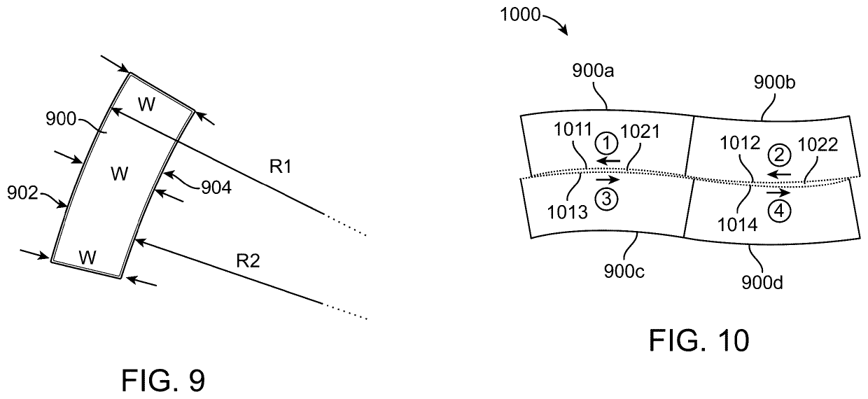

In some embodiments, the arcuate magnets can have a constant radial width. FIG. 9 shows a plan view of an arcuate magnet 900 that can be used in an annular magnetic alignment component (e.g., any of the annular magnetic alignment components described above). Arcuate magnet 900 has an outer arcuate surface 902 with a first radius of curvature R1 and an inner arcuate surface 904 with a second radius of curvature R2. In this example, R1 is greater than R2, and arcuate magnet 900 has a constant radial width (W) along its arc length. For example, R1 can be 26.46 mm, R2 can be 23.55 mm, and W can be 2.91 mm. It should be understood that R1, R2 and W are related; specifically, R1=R2+W. Where this relationship holds, the outer edge of an annular magnetic alignment component formed from arcuate magnets 900 will be a circle having radius R1 while the inner edge is a circle having radius R2.

Arcuate magnets 900 can be formed by laser cutting of a sheet of magnetic material that has been formed (e.g., by sintering) and ground to a desired thickness. FIG. 10 shows a simplified illustration of a pattern 1000 for laser-cutting multiple arcuate magnets 900a-900d from a sheet of magnetic material. As shown, cutting paths 1011 and 1014 form the inner arcuate surfaces of magnets 900a and 900d, while cutting paths 1012 and 1013 form the outer arcuate surfaces of magnets 900b and 900c. Because of the difference between R1 and R2, there is a gap 1021 between cutting paths 1011 and 1013 and a gap 1022 between cutting paths 1012 and 1014. In a manufacturing process, gaps 1021, 1022 result in wasted material. (This material may be recycled in some cases.) In addition, the cutting laser makes two passes between magnets 900a, 900c and two passes between magnets 900b, 900d.

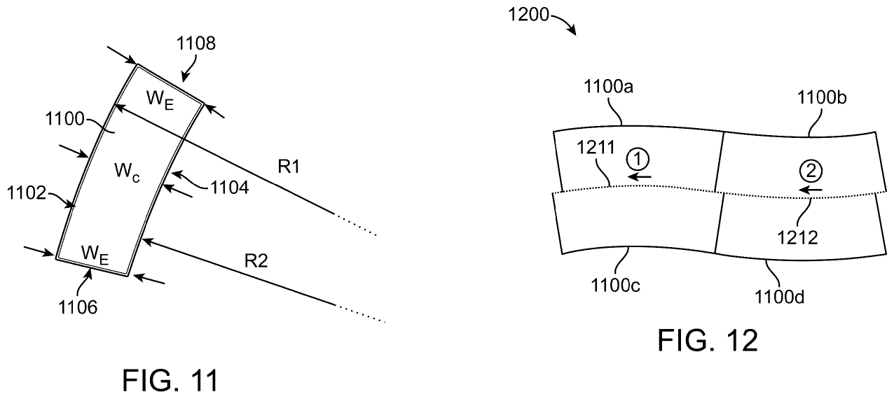

According to some embodiments, the shape of the arcuate magnets can be modified to reduce wasted material and the number of cutting passes required. FIG. 11 shows a plan view of an arcuate magnet 1100 according to some embodiments. Arcuate magnet 1100 can be used in an annular magnetic alignment component (e.g., any of the annular magnetic alignment components described above). Arcuate magnet 1100 has an outer arcuate surface 1102 with a radius of curvature R1 and an inner arcuate surface 1104 with a radius of curvature R2=R1. As a result of R2 and R1 being equal, arcuate magnet 1100 has a radial width that varies along the arc length of arcuate magnet 1100. In this example, the radial width is at its maximum (W_{C}) at the center and decreases symmetrically toward a minimum radial width (W_{E}) at side surfaces 908, 908. For example, R1 and R2 can be 26.46 mm, W_{C} can be 2.92 mm, and W_{E} can be 2.89 mm. It should be understood that the difference between W_{C} and W_{E} depends in part on the arc length of arcuate magnet 1100. In some embodiments, the arc length can be chosen such that the difference between W_{C} and W_{E} is small (e.g., between 1% and 2% of W_{C}). In this example, R1 is chosen to match the desired outer radius of an annular magnetic alignment component to be constructed using arcuate magnets 1100. Accordingly, the outer edge of an annular magnetic alignment component formed from arcuate magnets 1100 can be a circle having radius R1 while the inner edge has slight deviations from circularity. Such deviations can be small enough (e.g., 1-2%) that they do not affect performance of the annular magnetic alignment component.

Like arcuate magnets 900, arcuate magnets 1100 can be formed by laser cutting of a sheet of magnetic material that has been formed (e.g., by sintering) and ground to a desired thickness. FIG. 12 shows a simplified illustration of a pattern 1200 for laser-cutting multiple arcuate magnets 1100a-1100d from a sheet of magnetic material according to some embodiments. As shown, cutting path 1211 forms both the inner arcuate surface of magnet 1100a and the outer arcuate surface of magnet 1100c, while cutting path 1212 forms both the outer arcuate surface of magnet 1100b and the inner arcuate surface of magnet 1100d. Thus, a single pass of the cutting laser can be used to cut the inner and outer arcuate surfaces for the magnets on either side of the cut line. In addition, wasted material can be reduced, as there is no gap between adjacent arcuate edges of adjacent magnets cut using pattern 1200 (e.g., between magnets 1100a and 1100c or between magnets 1100b and 1100d). It should be understood that, by repeating pattern 1200, any number of arcuate magnets can be cut from a sheet of magnetic material, including more than two rows and/or more than two arcuate magnets per row. Magnetization can be applied after the arcuate magnets are cut and separated. It should be noted that the manufacturing technique illustrated in FIG. 12 can be applied to any arcuate magnets for an annular magnetic alignment component, regardless of the magnetization. For instance, referring to FIG. 3A, the technique described herein can be applied in manufacturing processes for secondary alignment component 310 and/or to primary alignment component 330. Similar techniques can also be applied to fabricate soft magnetic inserts for an annular magnetic alignment component (e.g., any of the inserts described above).

While the invention has been described with reference to specific embodiments, those skilled in the art will appreciate that variations and modifications are possible. For instance, although the annular alignment modules are described as being made from arcuate magnets, it will be understood that if the magnets are sufficiently small relative to the dimensions of the annular structure, trapezoidal or square magnets can approximate the behavior of arcuate magnets. Magnetic alignment components can have any dimensions, not limited to numerical examples provided above.

In addition, while a portable electronic device has been described as receiving power wirelessly, those skilled in the art will appreciate that an inductive power coil may be operable to transmit or receive power wirelessly, and in some embodiments a portable electronic device can be reconfigurable to operate either as a transmitter or receiver for wireless power transfer. Further, a portable electronic device may include multiple logic boards, and a soft magnetic insert in an annular magnetic alignment component can be used to provide shielding for any electronic component on any logic board that is affected by the annular magnetic alignment component. Further, while it is contemplated that annular magnetic alignment components of the kind described herein can be used to facilitate alignment between transmitter and receiver coils for wireless power transfer between devices, use of magnetic alignment components is not so limited, and annular magnetic alignment components can be used in a variety of contexts to hold one device in relative alignment with another, regardless of whether either or both devices have wireless charging coils.

All numerical values and ranges provided herein are illustrative and may be modified. Any measurements should be understood to be subject to manufacturing tolerances. Unless otherwise indicated, drawings should be understood as schematic and not to scale.

It should also be understood that, except where logic dictates otherwise, features shown or described with reference to one figure or example or embodiment can be combined with other features shown or described with reference to a different figure or example or embodiment. All processes described herein are also illustrative and can be modified. Operations can be performed in a different order from that described, to the extent that logic permits; operations described above may be omitted or combined; and operations not expressly described above may be added. In regard to any collection or exchange of information or data by or between devices, it is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Accordingly, although the invention has been described with respect to specific embodiments, it will be appreciated that the invention is intended to cover all modifications and equivalents within the scope of the following claims.

What is claimed is:

1. A magnetic alignment component comprising:
a plurality of arcuate magnets arranged end-to end to define an annular shape, the arcuate magnets being made of a permanent magnetic material and having a magnetic orientation with a component in a radial direction, the arcuate magnets further having a uniform height in an axial direction transverse to the annular shape and being further arranged such that a first gap in the annular shape is present between a first pair of the arcuate magnets; and
a first insert disposed in the first gap, the first insert being made of a soft magnetic material, the first insert having a height less than the uniform height of the arcuate magnets and an arcuate shape that fills the first gap.

2. The magnetic alignment component of claim 1 wherein the first insert is made of steel.

3. The magnetic alignment component of claim 1 wherein an inner radius of curvature of each of the arcuate magnets is equal to an outer radius of curvature of each of the arcuate magnets.

4. The magnetic alignment component of claim 3 wherein an inner radius of curvature of the first insert is equal to an outer radius of curvature of the first insert.

5. The magnetic alignment component of claim 1 wherein the arcuate magnets are arranged such that a second gap in the annular shape is present between a second pair of the arcuate magnets and wherein the magnetic alignment component further comprises a second insert disposed in the second gap, the second insert being made of a soft magnetic material, the second insert having a height equal to the uniform height of the arcuate magnets and an arcuate shape that closes the second gap.

6. The magnetic alignment component of claim 5 wherein the first gap and the second gap are separated by one arcuate magnet.

7. The magnetic alignment component of claim 5 wherein the first gap and the second gap are separated by two or more arcuate magnets.

8. An electronic device comprising:
a housing having a charging surface;
a logic board disposed in the housing and having electronic circuit components disposed thereon;
a magnetic alignment component disposed between the logic board and the charging surface such that at least a portion of the magnetic alignment component overlies a portion of the logic board, the magnetic alignment component comprising:
a plurality of arcuate magnets arranged end-to end to define an annular shape, the arcuate magnets being made of a permanent magnetic material and having a magnetic orientation with a component in a radial direction, the arcuate magnets further having a uniform height in an axial direction transverse to the annular shape and being further arranged such that a gap in the annular shape is present between a pair of the arcuate magnets; and
an arcuate insert disposed in the gap, the arcuate insert being made of a soft magnetic material, the arcuate insert having a height less than the uniform height of the arcuate magnets and an arcuate shape that fills the gap; and
an inductive charging coil disposed inboard of and coaxial with the magnetic alignment component.

9. The electronic device of claim 8 wherein an electrical connection to the inductive charging coil passes over the arcuate insert.

10. The electronic device of claim 8 wherein the gap is in the portion of the magnetic alignment component that overlies the logic board.

11. An electronic device comprising:
a housing having a charging surface;
a logic board disposed in the housing and having electronic circuit components disposed thereon;
a magnetic alignment component disposed between the logic board and the charging surface such that at least a portion of the magnetic alignment component overlies a portion of the logic board, the magnetic alignment component comprising:
a plurality of arcuate magnets arranged end-to end to define an annular shape, the arcuate magnets being made of a permanent magnetic material and having a magnetic orientation with a component in a radial direction, the arcuate magnets further having a uniform height in an axial direction transverse to the annular shape and being further arranged such that a first gap in the annular shape is present between a first pair of the arcuate magnets and a second gap in the annular shape is present between a second pair of the arcuate magnets;
a first insert disposed in the first gap, the first insert being made of a soft magnetic material, the first insert having a height less than the uniform height of the arcuate magnets and an arcuate shape that fills the first gap; and
a second insert disposed in the second gap, the second insert being made of a soft magnetic material, the second insert having a height equal to the uniform height of the arcuate magnets and an arcuate shape that fills the second gap; and
an inductive charging coil disposed inboard of and coaxial with the magnetic alignment component.

12. The electronic device of claim 11 wherein an electrical connection to the inductive charging coil passes over the first insert.

13. The electronic device of claim 11 wherein the first gap is in the portion of the magnetic alignment component that overlies the logic board.

14. The electronic device of claim 11 wherein the second gap is in a portion of the magnetic alignment component that overlies an inductor component on the logic board.

15. The electronic device of claim 14 wherein an arc length of the second gap and the second insert is selected to minimize a net force acting on the inductor component on the logic board.

16. The electronic device of claim 11 wherein an arc length of the first insert and an arc length of the second insert are equal.

17. The electronic device of claim 16 wherein each of the arcuate magnets has an arc length equal to the arc length of the first insert.

18. The electronic device of claim 11 wherein the first insert has a first arc length, the second insert has a second arc length, and the first arc length is different from the second arc length.

19. The electronic device of claim 18 wherein each of the arcuate magnets has a third arc length and wherein a sum of the first arc length and the second arc length is equal to twice the third arc length.

20. The electronic device of claim 11 wherein an inner radius of curvature of each of the arcuate magnets is equal to an outer radius of curvature of each of the arcuate magnets.
